(19) United States
(12) Patent Application Publication
(10) Pub. No.: US 2006/0292351 A1
(43) Pub. Date: Dec. 28, 2006

(54) Composite decoration faceplate

(75) Inventor: Heng-Yen Liu, Taipei City (TW)

Correspondence Address: TROXELL LAW OFFICE PLLC, SUITE 1404, 5205 LEESBURG PIKE, FALLS CHURCH, VA, 22041, US

(73) Assignee: Hocheng Corporation

(21) Appl. No.: 11/271,895

(22) Filed: Nov. 14, 2005

(30) Foreign Application Priority Data
Jun. 17, 2005 (TW) 094210238

(51) Int. Cl. B32B 27/04; B32B 23/02; B32B 27/12

(52) U.S. Cl. 428/192; 442/103; 428/195.1; 428/174

(57) ABSTRACT

The present invention uses a fabric layer with a pattern covered by a cover layer of resin where the feel and appearance of an electronic device are improved by being applied with a faceplate containing the fabric layer while the working hour is reduced and the working procedure is simplified.

### FIELD OF THE INVENTION

The present invention relates to a decoration faceplate; more particularly, relates to applying on an electronic device where, on forming the faceplate, working hour is reduced and working procedure is simplified; and the feel and appearance of the electronic device are improved.

### DESCRIPTION OF THE RELATED ART

A prior art, “A mobile information terminal and a faceplate thereof”, is proclaimed in Taiwan, as shown in FIG. 6, which comprises a main shell 3 and a faceplate 4 on the surface of the main shell 3, characterized in that the main shell 3 comprises two side parts 31 roughly parallel and two slender grooves 32 extending outwardly a long the side parts 31 as an openning; the faceplate 4 comprises protruding parts 41 along the side parts 31 extending inwardly; and, by sliding the faceplate 4 along the main shell 3, the protruding parts 41 are locked in the slender grooves 31 to install the faceplate 4 on the main shell 3.

The prior art installs the face plate 4 on the main shell 3 by sliding the faceplate 4 along the main shell 3. Yet, the faceplate 4 is made of a general plastic material and is obtained by plastic injection to form the protruding parts 41 on two sides of the faceplate 4 at the same time. In addition, two side parts 31 and two slender grooves 32 have to be set on the main shell 3 for coordination. Therefore, working hour is long and working procedure is complex, And, although the plastic faceplate 4 can be easily replaced, the plastic faceplate 4 comprises an appearance not beautifull enough and a feel not good enough. Hence, the prior art does not fulfill users' requests on actual use.

### SUMMARY OF THE INVENTION

The main purpose of the present invention is to weave out a pattern area when forming a fabric layer and to further reduce working hour and simplify working procedure, and to improve feel and appearance of an electronic device by applying a faceplate containing the fabric layer to the electronic device.

To achieve the above purpose, the present invention is a composite decoration faceplate, comprising a fabric layer obtained by weaving reinforcing materials interlaced in longitudinal and latitudinal directions; a pattern area formed on a surface of the fabric layer; and a cover layer obtained on a surface of the fabric layer covering the pattern area. Accordingly, a novel composite decoration faceplate is obtained.

### BRIEF DESCRIPTION OF THE DRAWINGS

The present invention will be better understood from the following detailed descriptions of the preferred embodiments according to the present invention, taken in conjunction with the accompanying drawings, in which

FIG. 1 is a perspective view of a first preferred embodiment according to the present invention;

FIG. 2 is a local enlargement view of notatoin 13 of FIG. 1;

FIG. 3 is a cross-sectional view of A-A of FIG. 1;

FIG. 4 is a perspective view of a second preferred embodiment according to the present invention;

FIG. 5 is a view showing a state of use of the preferred embodiment according to the present invention;

FIG. 6 is a perspective view of a prior art.

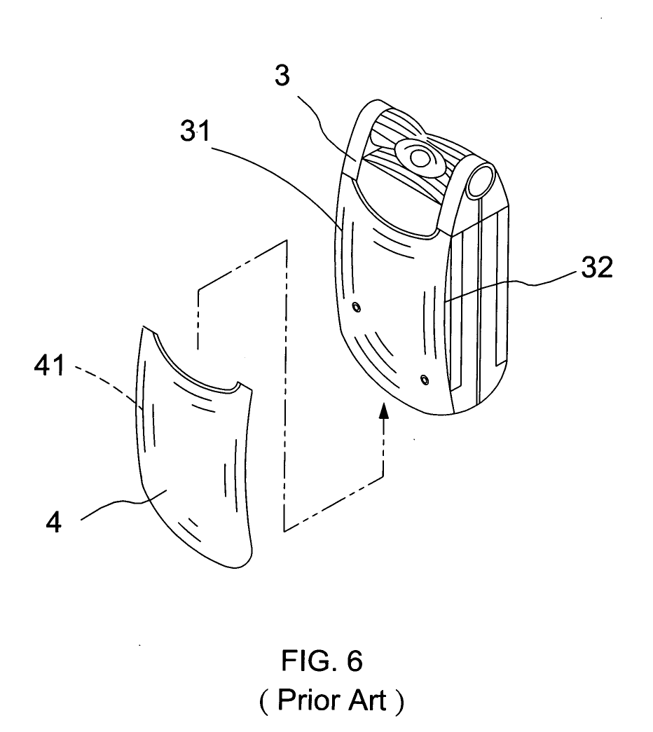

### DESCRIPTION OF THE PREFERRED EMBODIMENTS

The following descriptions of the preferred embodiments are provided to understand the features and the structures of the present invention.

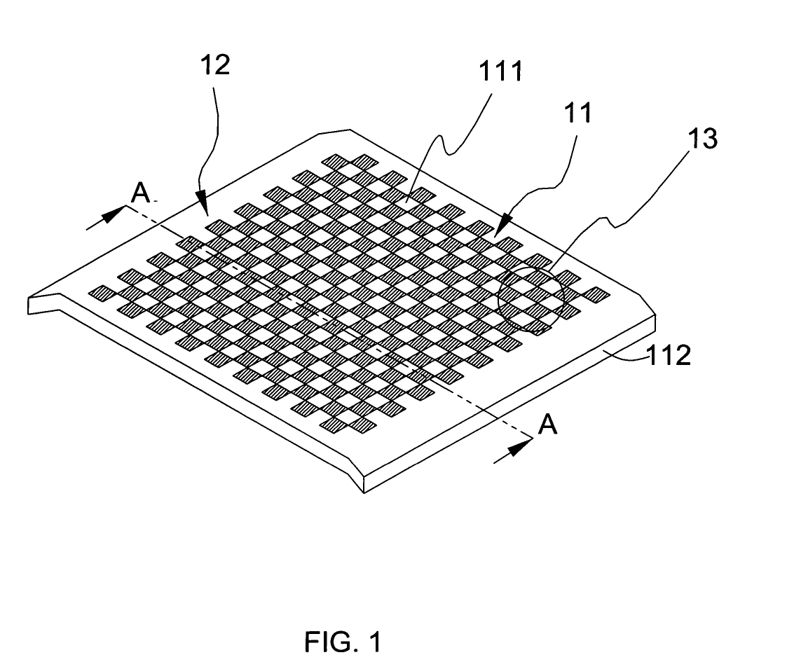

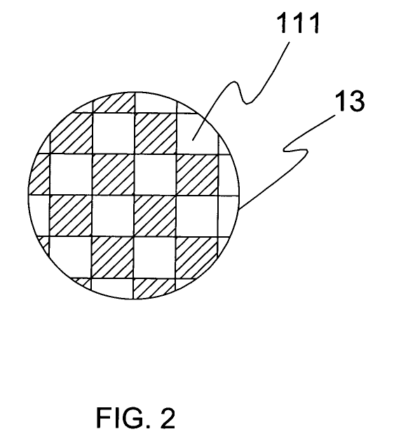

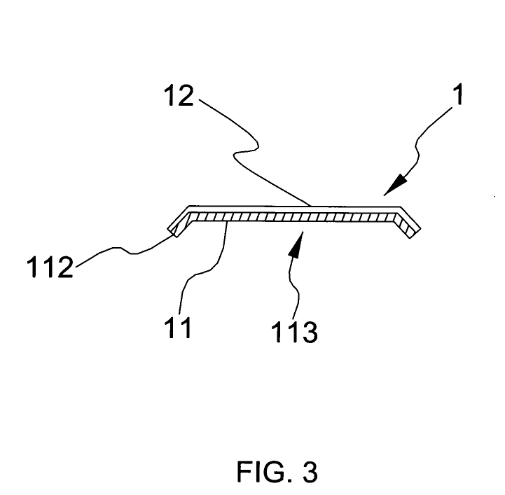

Please refer to FIG. 1 through FIG. 3, which are a penetrating view of a preferred embodiment according to the present invention, a local enlargement view of notatoin 13 of FIG. 1 and a cross-sectional view of A-A of FIG. 1. As shown in the figures, the present invention is a composite decoration faceplate, comprising a fabric layer 11, a pattern area 114 and a cover layer 12, where the working hour is shortened and the working procedure is simplified on producing the faceplate; and the feel and the appearance of an electronic device are enhenced.

The fabric layer 11 is obtained by weaving a reinforcing material 111 interlaced in longitudinal and latitudinal directions. The reinforcing material 111 can be a glass fiber or a carbon fiber. The fabric layer 11 comprises angled borders 112 at side rims to obtain adhering part 113 among the angled borders 112 according to the shape of the electronic device. The pattern area 114 is deposed on a surface of the fabric layer 11. The cover layer 12 is deposed on the fabric layer 11 covering the pattern area 114 and is made of a resin-based material. The resin can be hardened into a transparent or semi-transparent material by heat or under room-temperature. Thus, a novel, smooth and bright composite decoration faceplate is obtained with resin weaved in a mold or on a flat surface as being hardened afterward.

On producing a faceplate 1, a reinforcing material 111 is deposed on a working platform to be weaved and interlaced in longitudinal and latitudinal directions to obtain a fabric layer 11 of required size and shape. When obtaining the fabric layer 11, the reinforcing material 111 is dipped into a resin so that fabric layer is saoked with a resin in seams. After the weaving done on the working platform, a cover layer 12 is formed on the fabric layer 11 accordingly. Besides, when the reinforcing material 111 is weaved to obtain the fabric layer 11, the working platform can be set to weave out required pattern area 114 on the fabric layer 11. Hence, the cover layer 12 and the pattern area 114 are obtained when forming the fabric layer 11 where working hour is shortened and the working procedure is simplified on producing the faceplate 1.

The pattern area 114 can be obtained in the above way; or, the pattern area 114 can be obtained on the fabric layer 11 by a trans-printing.

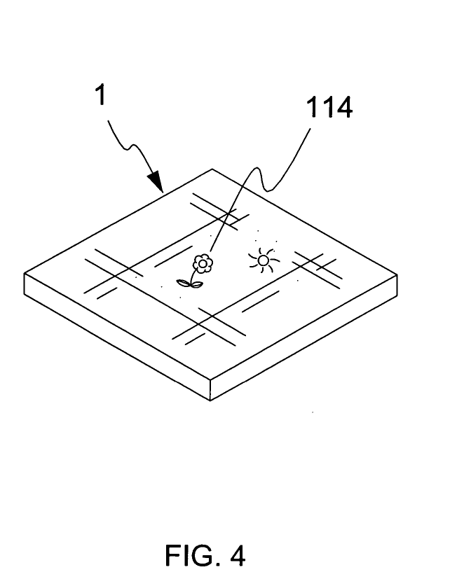

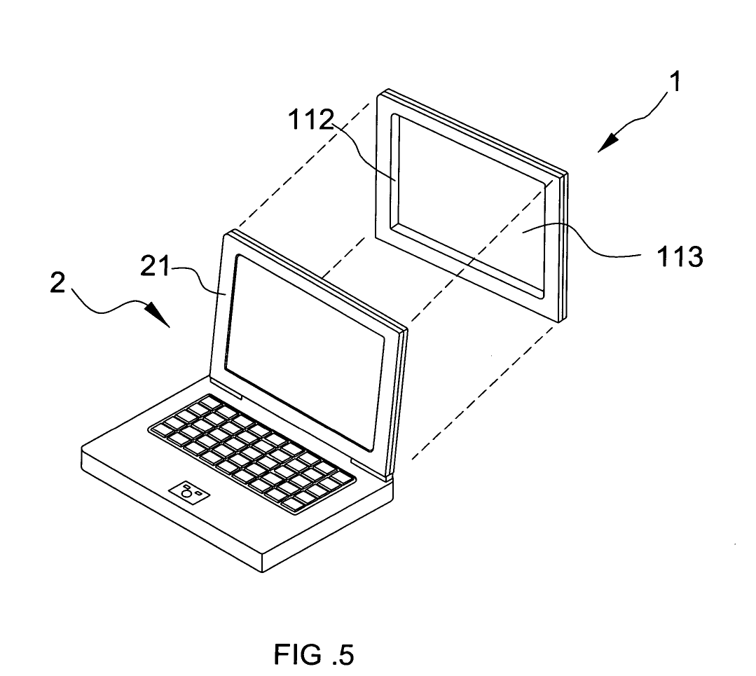

Please refer to FIG. 4 and FIG. 5, which are a view showing a state of use of the first preferred embodiment and a perspective view of the second preferred embodiment according to the present invention. As shown in the figures, when applying to an electronic device of a notebook 2, for example, a faceplate 1 is corresponding to an outside surface (the side opposite to the screen of the notebook 2) and is set on the outside surface of the monitor 21. Therein, the angled borders 112 of the fabric layer 11 are corresponding to the outer rims of the monitor 21. And the fabric layer 11 of the faceplate 1 is pasted and adhered to the monitor 21 with an adhesive. In the other hand, the fabric layer 11 can be flat, as shown in FIG. 5, to be directly set on outside surface of the monitor 21. Thus, the faceplate 1 is set on the outside surface of the monitor 21 so that the cover layer 12 and the pattern are a 114 on the fabric layer 11 are set on the outside surface of the notebook 2 to add feel and appearance of the electronic device, which is the notebook 2.

To sum up, the present invention is a composite decoration faceplate, where a reinforcing material is weaved to obtain a fabric layer with a pattern area as the working hour is reduced and the working procedure is simplified; and, when a faceplate containing the fabric layer is applied to an electronic device, a feel is emhanced and an appearance is improved to further achieve a stability on using.

The preferred embodiments herein disclosed are not intended to unnecessarily limit the scope of the invention. Therefore, simple modifications or variations belonging to the equivalent of the scope of the claims and the instructions disclosed herein for a patent are all within the scope of the present invention.

What is claimed is:

1. A composite decoration faceplate, comprising:
(a) a fabric layer obtained by weaving a plurality of reinforcing materials to be interlaced in longitudinal and latitudinal directions;
(b) a pattern area deposed on said fabric layer; and
(c) a cover layer deposed on surface of said fabric layer, said cover layer covering said pattern area.

2. The faceplate according to claim 1,
wherein a shape of said fabric layer is corresponding to a shape of an electronic device;
wherein said fabric layer comprises angled borders at side rims to obtain an adhering part among borders; and
wherein said adhering part is adhered to said electronic device.

3. The faceplate according to claim 1,
wherein a shape of said fabric layer is corresponding to a shape of an electronic device;
wherein said fabric layer is flat and is adhered to said electronic device.

4. The faceplate according to claim 1, wherein said fabric layer is saoked with a resin in seams to obtain a cover layer on said fabric layer after said resin is hardened.

5. The faceplate according to claim 4, wherein said resin is hardened to obtain a transparent material.

6. The faceplate according to claim 4, wherein said resin is hardened to obtain a semi-transparent material.

7. The faceplate according to claim 1, wherein said reinforcing material is selected from a group consisting of a glass fiber and a carbon fiber.

8. The face plate according to claim 1, wherein said pattern area is weaved on said fabric layer

9. The faceplate according to claim 1, wherein said pattern area is obtained on said fabric layer through a trans-printing.
